(19) United States
(12) Patent Application Publication
(10) Pub. No.: US 2015/0310530 A1
(43) Pub. Date: Oct. 29, 2015

(54) NAVIGATION AND RECOMMENDATION ON PAYMENT CHECKOUT IN A PROFESSIONAL SOCIAL NETWORK

(71) Applicant: LinkedIn Corporation, Mountain View, CA (US)

(72) Inventors: Yongzheng Zhang, San Jose, CA (US); Chi-Yi Kuan, Fremont, CA (US)

(73) Assignee: Linkedln Corporation, Mountain View, CA (US)

(21) Appl. No.: 14/265,196

(22) Filed: Apr. 29, 2014

(51) Int. Cl. G06Q 30/06; G06Q 50/00

(52) U.S. Cl. CPC G06Q 30/0631; G06Q 50/01

(57) ABSTRACT

Techniques for providing a member of a social, professional or business networking service with a product purchase recommendation based on products previously purchased by similar members in the social networking service are described. With some embodiments, a general recommendation engine is used to determine a first member is attempting to make a product purchase decision. The recommendation engine identifies members similar to the first member and identifies their product browsing patterns, which resulted in a product purchase, that are similar to the first member's current product browsing pattern. The recommendation engine determines a product recommendation based on the products purchased by the similar members. As the first member's current product browsing pattern changes, the recommendation engine dynamically changes the product recommendation and displays the product recommendation to the first member.

### TECHNICAL FIELD

The present disclosure generally relates to data processing systems. More specifically, the present disclosure relates to methods, systems and computer program products for identifying one or more product purchase recommendations for a member of an online social networking service, or business networking service, based at least in part on the profiles and behaviors of other members who have previously purchased a product.

### BACKGROUND

A social networking service is a computer- or web-based application that enables users to establish links or connections with persons for the purpose of sharing information with one another. Some social networks aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the FIGs. of the accompanying drawings, in which:

FIG. 1 is a block diagram illustrating various components of a social network with a recommendation engine for identifying similarities between users, their respective browsing patterns and their product purchases, consistent with some embodiments of the invention.

FIG. 2 is a block diagram showing some of the components or modules that comprise a recommendation engine and illustrates the flow of data, consistent with some embodiments of the invention, that occurs when performing various operations of a method for identifying similar users and determining a product recommendation for a user attempting to make a product purchase decision.

FIG. 3 is a flow diagram illustrating an example of the method operations involved in a method of providing a user of a social network with a product purchase recommendation based on products previously purchased by similar users in the social network, according to some embodiments of the invention.

FIG. 4 is a flow diagram illustrating an example of the method operations involved in a method of dynamically providing a user of a social network with updated product purchase recommendations as the current activity of the user changes, according to some embodiments of the invention.

FIG. 5 is a diagram illustrating a product recommendation being determined according to some embodiments of the invention.

FIG. 6 is a block diagram of a machine in the form of a computing device within which a set of instructions, for causing the machine to perform any one or more of the methodologies discussed herein, may be executed.

### DETAILED DESCRIPTION

The present disclosure describes methods and systems for providing a user who is a member of a social, professional or business networking service (“social network”) with a product purchase recommendation based on products previously purchased by similar users in the social network service (“social network”). In the following description, for purposes of explanation, numerous specific details are set forth in order to provide a thorough understanding of the various aspects of different embodiments of the present invention. It will be evident, however, to one skilled in the art, that the present invention may be practiced without all of the specific details. It is understood that a product, in various embodiments, can be an online product or an online subscription service.

Consistent with embodiments of the invention, and as described in detail herein, a social network includes the necessary logic for a recommendation engine to determine that a first user in the social network is currently attempting to make a product purchase decision. The recommendation engine determines a product recommendation for the first user based on respective browsing behaviors of a subset of users in the social network and provides the product recommendation to the first user. It is understood that a browsing behaviour (or browsing pattern) can include a sequence of user actions, such as: page views, icon selections, link selections, searches, computer mouse activity and/or product purchases.

According to embodiments described herein, the recommendation engine determines the first user is currently attempting to make a product purchase decision. The recommendation engine identifies users who are similar to the first user based on similarities between their respective social network profiles (i.e. member profiles) and/or similarities between their previous browsing patterns in various portions of the social network. A similarity can also be determined at least in part on a social network distance (i.e. degrees of separation) between the users.

The recommendation engine identifies various product browsing patterns of the similar users. That is, in one embodiment, the recommendation engine identifies browsing patterns executed by similar users which resulted in a purchase of a product(s) sold through the social network. The recommendation engine determines a product recommendation based on products purchased as a result of product browsing patterns similar to the browsing pattern currently being exhibited by the first user as the first user attempts to make a product purchase decision.

By identifying product browsing patterns of similar users—which resulted in a product purchase—the recommendation engine recommends a product the first user is most likely to purchase, thereby decreasing the amount of time the first user will take to make a purchase decision. As the first user's current product browsing pattern changes, the recommendation engine dynamically changes the product recommendation and displays the product recommendation to the first user.

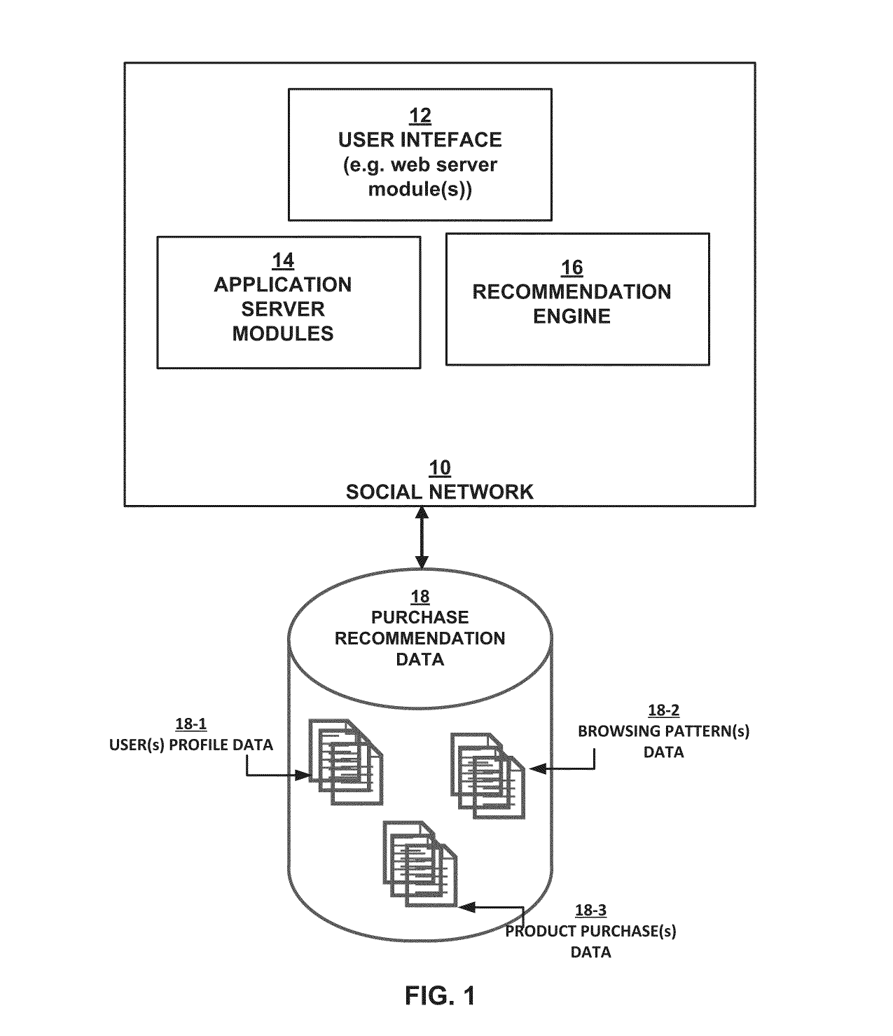

FIG. 1 is a block diagram illustrating various components of a social network 10 with a recommendation engine 16 for identifying similarities between users, their respective browsing patterns and their product purchases consistent with some embodiments of the invention.

As shown in FIG. 1, the social network 10 is generally based on an architecture consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system such as that illustrated in FIG. 1, to facilitate additional functionality that is not specifically described herein. Furthermore, the various functional modules and engines depicted in FIG. 1 may reside on a single server computer, or may be distributed across several server computers in various arrangements, such as in a cloud computing environment, for example.

As shown in FIG. 1, the front end layer consists of a user interface module (e.g., a web server) 12, which receives requests from various client computing devices, and communicates appropriate responses to the requesting client devices. For example, the user interface module(s) 12 may receive requests in the form of Hypertext Transport Protocol (HTTP) requests, or other web-based, application programming interface (API) requests. The application logic layer includes various application server modules 14, which, in conjunction with the user interface module(s) 12, generates various user interfaces (e.g., web pages) with data retrieved from various data sources in the data layer.

With some embodiments, individual application server modules 14 are used to implement the functionality associated with various services and features of the social networking service, such as e-commerce (i.e. purchase check-out) portions of the social network, and tracking and collection of various users' browsing patterns and product purchases. Similarly, other applications or services that utilize the recommendation engine 16 will be embodied in their own application server modules 14. For example, in one embodiment, the recommendation engine 16 can be embodied with respect to a mobile payment application, where product recommendations are generated and sent by the recommendation engine 16 for display on a wireless mobile device and payments for products and/or service are received from the wireless mobile device.

As shown in FIG. 1, the data layer can include at least one database for storing various types of data, such as, for example, a database for storing purchase recommendation data 18. The purchase recommendation data 18 includes user(s) profile data 18-1, browsing pattern(s) data 18-2, product purchase(s) data 18-3 and so forth. With some embodiments, the purchase recommendation data 18 is processed in the background (e.g., offline) to generate pre-processed recommendation data, that can be used by the recommendation engine 16, in real-time, to make product recommendations generally, and to identify previous product purchases made by other users that a particular user is most likely to purchase as the particular user attempts to make a product purchase decision.

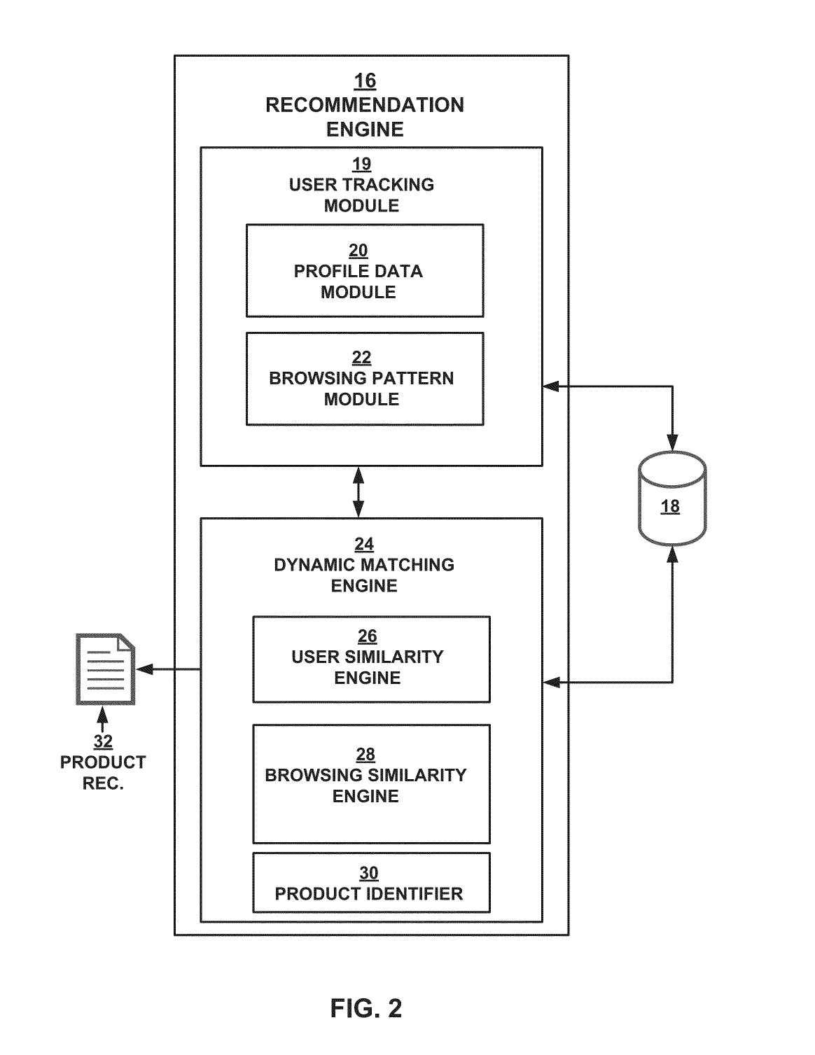

FIG. 2 is a block diagram showing some of the components or modules that comprise a recommendation engine 16 and illustrates the flow of data, consistent with some embodiments of the invention, that occurs when performing various operations of a method for identifying similar users and determining a product recommendation 32 for a user attempting to make a product purchase decision.

As illustrated in FIG. 2, the recommendation engine 16 consists of two primary functional modules—a user tracking module 19 and a dynamic matching engine 24. With some embodiments, the recommendation engine 16 is a general recommendation engine that can be configured and/or customized to identify similarities (and differences) between various users in the social network 10 and similarities between the browsing patterns and product purchases of various users.

The user tracking module 19 determines that a first user is attempting to make a product purchase decision. For example, the user tracking module 19 detects that the first user is viewing a webpage(s) in which products are described, or that the first user has requested a product purchase portion of the social network 10.

The user tracking module 19 consists of two primary functional modules—a profile data module 20 and a browsing pattern module 22. The profile data module 20 extracts data from the first user's social network profile. The profile data module 20 can also receive pre-processed data about the first user stored in the purchase recommendation data 18. The browsing pattern module 22 continually monitors the first user's activity as the first user attempts to make a product purchase decision.

The user tracking module 19 sends data about the first user and the first user's current activity (i.e. current browsing pattern) to a dynamic matching engine 24. The dynamic matching engine 24 consists of three primary functional modules—a user similarity engine 26, a browsing similarity engine 28 and a product identifier 30. It is understood that the user tracking module 19 continually sends updated data about the first user's current activity as it changes.

The dynamic matching engine 24 receives data about other users in the social network 10 from the purchase recommendation data 18. The user similarity engine 26 identifies other users that are similar to the first user by comparing data about their respective social network profiles and their respective previous browsing patterns.

The browsing similarity engine 28 identifies previous browsing patterns of similar users that resulted in a product purchase (hereinafter “product purchase patterns”). The browsing similarity engine 28 dynamically compares the product purchase patterns with the current activity of the first user, even as the current activity of the first user is continually tracked and updated by the browsing pattern module 22.

The browsing similarity engine 28 continually and dynamically identifies product purchase patterns from similar users that meet a threshold of similarity with the first user's current activity. The product identifier 30 identifies the product(s) most often purchased from the product browsing patterns that meet the threshold of similarity. The product identifier 30 generates a product recommendation(s) 32 based on the product(s) most often purchased as a result of the product purchase browsing patterns that meet the threshold of similarity.

The recommendation engine 16 provides the product recommendation(s) 32 to the first user. It is understood that as the first user's current activity continually changes, the recommendation engine 16 provides updated product recommendation(s) 32 that take into account the changes in the first user's current activity.

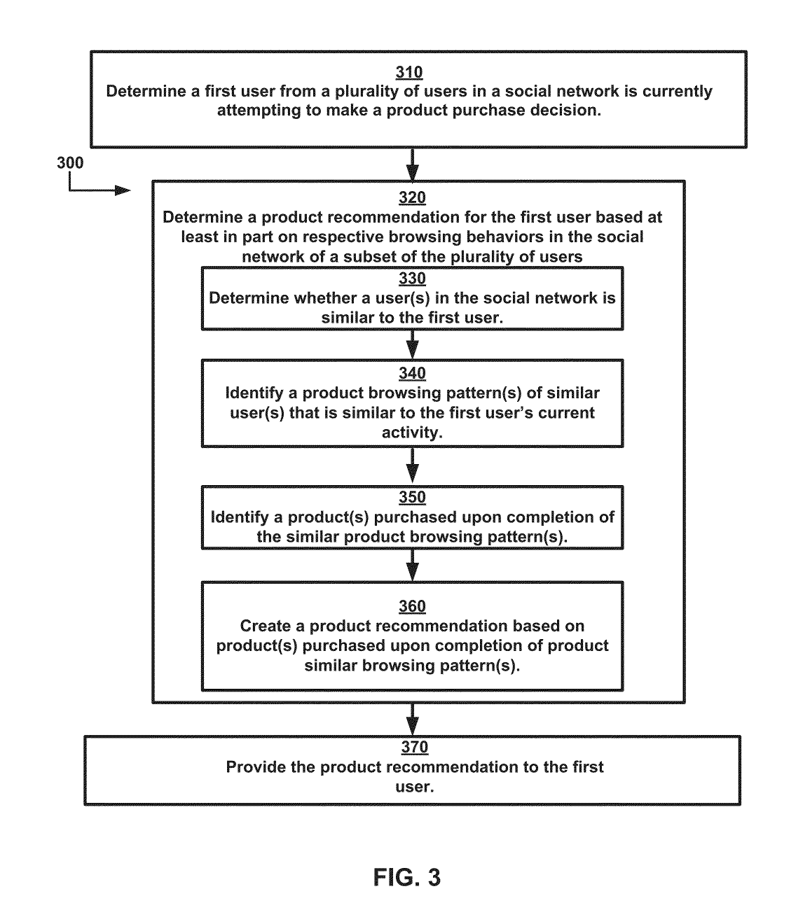

FIG. 3 is a flow diagram 300 illustrating an example of the method operations involved in a method of providing a user (or member) of a social network 10 with a product purchase recommendation 32 based on products previously purchased by similar users in the social network 10, according to some embodiments of the invention.

Some of the method operations illustrated in FIG. 3 may be performed offline by means of a batch process that is performed periodically (e.g., two times a day, daily, weekly, and so forth), while in other embodiments, the method operations may be performed online and in real-time as a particular user attempts to make a purchase decision.

At step 310, the recommendation engine 16 determines a first user (who is a member of the social network 10) from a plurality of users (i.e. members) in a social network 10 is currently attempting to make a product purchase decision. According to some embodiments, the recommendation engine 16 engine detects the first user is accessing a product webpage(s) in the social network 10 that describes a product(s) available for purchase. The recommendation engine 16 determines the first user is attempting to make a purchase decision based on the first user's activity with respect to viewing the product webpage(s). For example, if the recommendation engine 16 detects the first user has browsed between various product webpages within a certain amount of time, or has viewed the same product webpage(s) within a certain amount of time, the recommendation engine 16 infers that the first user is attempting to make a product purchase decision.

According to other embodiments, the recommendation engine 16 detects the first user is accessing a product purchase portion of the social network 10. The recommendation engine 16 determines the first user is attempting to make a purchase decision based on the first user's activity with respect to a webpage(s) that provides functionality for purchase of a product. For example, if the recommendation engine 16 detects the first user has begun to provide information necessary for a transaction, the recommendation engine 16 infers that the first user is attempting to make a product purchase decision.

At step 320, the recommendation engine 16 determines a product recommendation 32 for the first user based at least in part on respective browsing behaviors in the social network of a subset of the plurality of users. Browsing behaviors (i.e. browsing patterns) include any user activity in the social network, such as: webpage views, a sequence of webpage views, how often and/or when a user(s) typically accesses the social network, icon selections, link selections, searches, computer mouse activity and/or product purchases.

In order to determine the product recommendation 32, at step 330, the recommendation engine 16 determines whether at least one user in the social network 10 is similar to the first user. A user(s) in the social network can be considered similar to the first user if their respective social network profile data meet a threshold of similarity. Social network profile data can include, for example: an education attribute(s), an employer attribute(s), a previous employer attribute(s), a skills attribute(s), a geographic attribute(s), and an attribute(s) provided by other users in the social network.

Upon determining a similar user(s), at step 340, the recommendation engine 16 identifies a product browsing pattern(s) associated with the similar user(s). A product browsing pattern is any kind of browsing pattern that resulted in an actual purchase of a product through the social network 10. In some embodiments, the recommendation engine 16 identifies a product browsing pattern(s) of a similar user(s) that meets a threshold of similarity with the first user's current activity as the first user attempts to make a product purchase decision.

At step 350, the recommendation engine 16 identifies a product(s) purchased upon completion of the product browsing pattern. At step 360, the recommendation engine 16 creates the product recommendation 32 based at least in part on the product(s) purchased upon completion of the product browsing pattern(s) that are similar to the first user's current activity. At step 370, the recommendation engine 16 provides the product recommendation 32 to the first user.

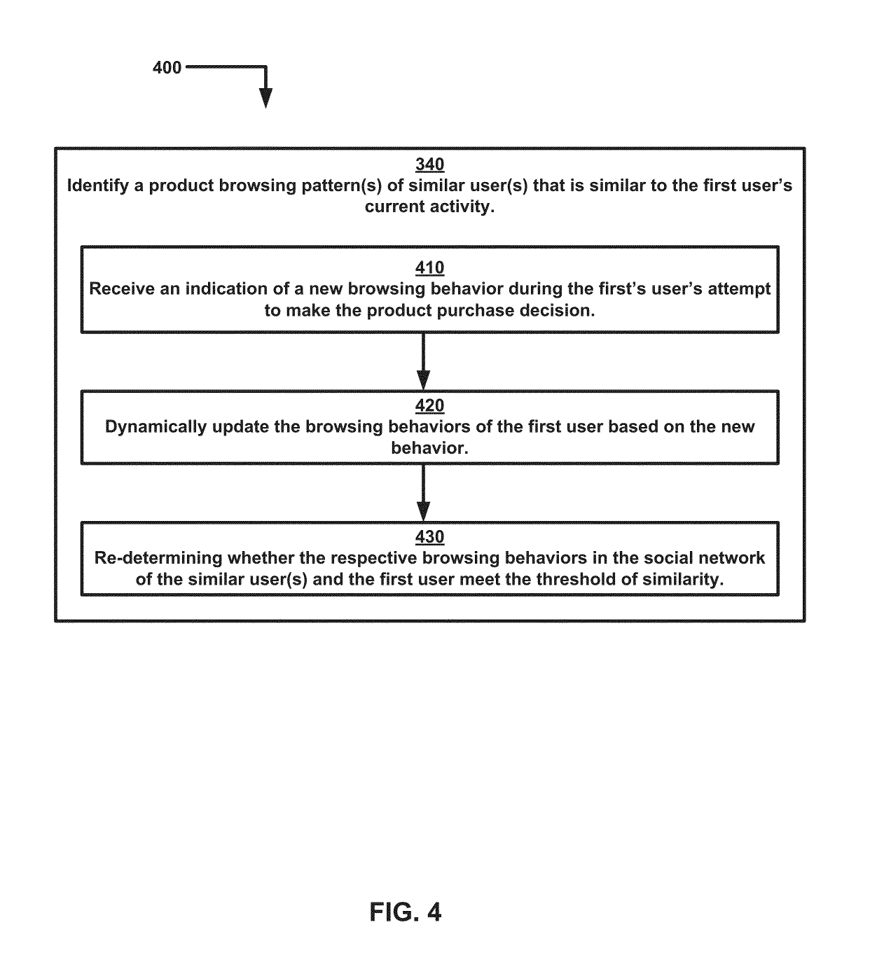

FIG. 4 is a flow diagram 400 illustrating an example of the method operations involved in a method of dynamically providing a user of a social network 10 with updated product purchase recommendations as the current activity of the user changes, according to some embodiments of the invention.

At step 410, the recommendation engine 16 receives an indication of a new browsing behaviour(s) during the first user's attempt to make the product purchase decision. For example, in various embodiments, the recommendation engine 16 detects that the first user continues to view a particular product(s) webpage, has selected a particular icon or link, has modified his social network profile data and/or has selected a product(s) to purchase but has now modified or somehow changed his purchase order.

At step 420, the recommendation engine 16 dynamically updates the browsing behaviors of the first user based on the new behaviour. As the first user's current activity changes while the first user attempts to make a purchase decision, the recommendation engine 16 dynamically updates data based on tracking the first user's activity, which is used to determine the product recommendation 32.

At step 440, the recommendation engine 16 re-determines whether the respective browsing behaviors of the user(s) and the first user meet the threshold of similarity. As described above, the recommendation engine 16 identifies a product browsing pattern(s) associated with the similar user(s). The product browsing pattern(s) is continually compared to the first user's current activity, even as the first user's current activity dynamically changes.

It is also noted that, in some embodiments, the recommendation engine 16 dynamically accounts for changes in the first user's current activity when identifying a similar user(s) as well. As the first user's current activity changes, some users may be deemed more similar to the first user than other users. Therefore, the recommendation engine 16 dynamically changes the subset of similar users—and their respective product browsing patterns—used to determine the product recommendation 32 as the first user browses the social network.

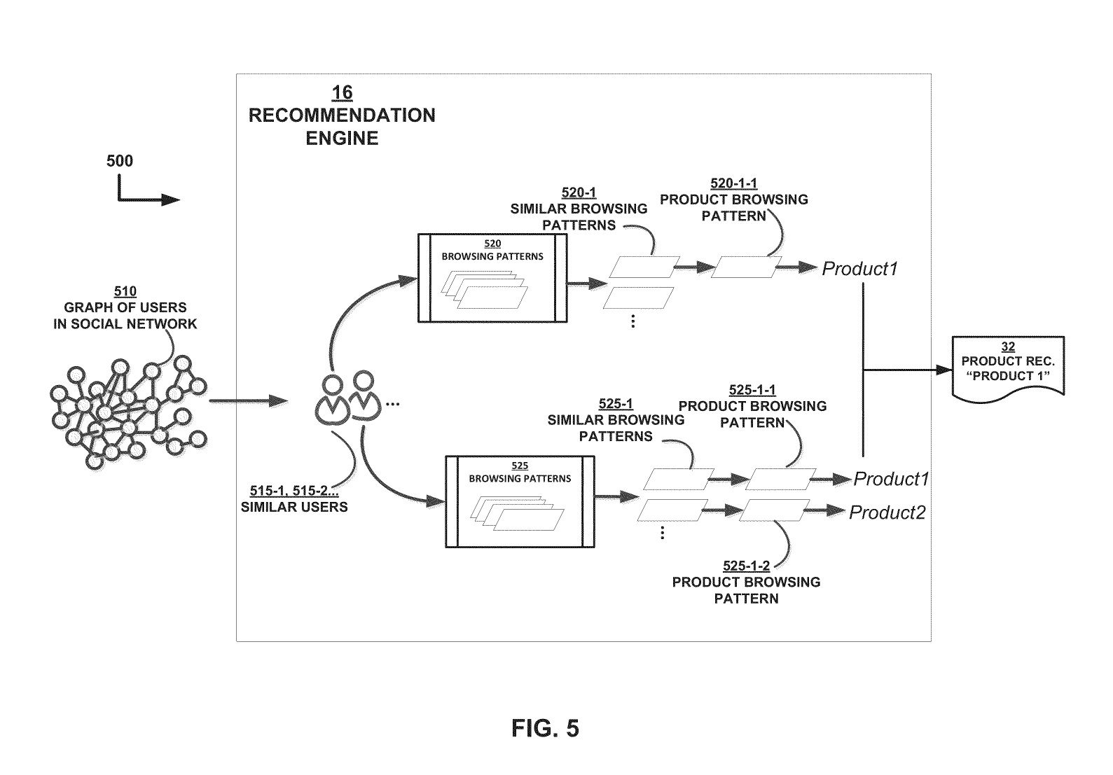

FIG. 5 is a diagram 500 illustrating a product recommendation being determined according to some embodiments of the invention. The diagram 500 illustrates a graph 510 of all the connections between users in a social network 10. The social network 10 offers products (i.e. subscriptions, services, etc.) available for purchase through an e-commerce portion of the social network 10. As described above, a recommendation engine 16 processes social network data as a first user attempts to make a purchase decision in order to provide a product recommendation(s) 32 to the first user.

The recommendation engine 16 continually and dynamically detects and processes data regarding the first user as the first user browses through the social network 10 in order to make a purchase decision. The recommendation engine 16 identifies similar users 515-1, 515-2 . . . from the users in the social network 10 based on similarities between browsing patterns, social network profile data, and social network distances of the first user and the similar users 515-1, 515-2 . . . . It is understood that as the first user's current activity changes, the users the recommendation engine 16 has identified as similar users 515-1, 515-2 . . . may be modified since identification of similar users may be based at least in part on how similar their respective browsing patterns are to the first user's current activity.

The recommendation engine 16 identifies browsing patterns 520, 525 . . . of the similar users 515-1, 515-2 . . . , respectively. From the identified browsing patterns 520, 525 . . . , the recommendation engine 16 identifies browsing patterns 520-1, 525-1 that are similar to the first user's current activity. Again, as with identifying the similar users 515-1, 515-2 . . . , the recommendation engine 16 identifies similar browsing patterns 520-1, 525-1 . . . while taking into account real-time changes occurring in the first user's current activity.

The recommendation engine 16 identifies browsing patters 520-1-1, 525-1-1, 525-1-2 from the similar browsing patterns 520-1, 525-1 . . . , which resulted in a purchase of a product by a similar user 515-1, 515-2 . . . . The purchased products are identified and a product recommendation 32 for the first user is determined based at least in part on the identified purchased products.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

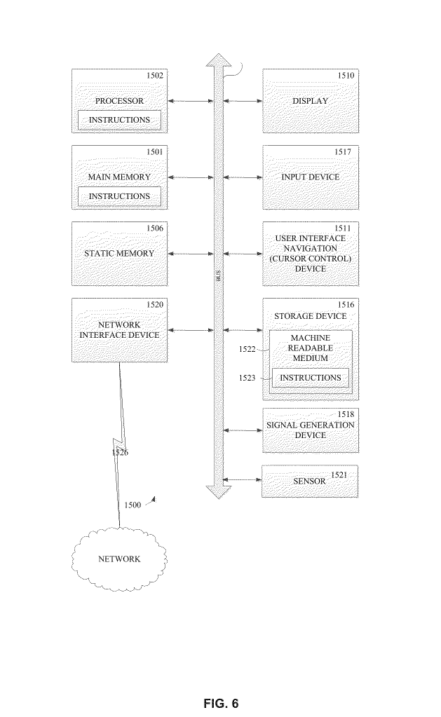

FIG. 6 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
determining a first member from a plurality of members in a social networking service is currently attempting to make a product purchase decision;
determining a product recommendation for the first member based at least in part on respective browsing behaviors in the social networking service of a subset of the plurality of members; and
providing the product recommendation to the first member.

2. The computer-implemented method of claim 1, wherein determining a first member from a plurality of members is making a product purchase decision comprises one of:
determining the first member is browsing products available for purchase via the social networking service; and
determining the first member has requested a particular user interface of a product purchase portion from the social networking service.

3. The computer-implemented of claim 1, wherein determining a product recommendation for the first member based at least in part on respective browsing behaviors in the social networking service of a subset of the plurality of members comprises:
determining whether at least one member in the social networking service is similar to the first member;
upon determining a similarity between the at least one member and the first, member, identifying a product browsing pattern associated with the at least one member;
identifying a product purchased upon completion of the product browsing pattern; and
creating the product recommendation based at least in part on the product purchased upon completion of the product browsing pattern.

4. The computer-implemented of claim 3, wherein determining whether at least one member in the social networking service similar to the first member comprises:
determining whether respective browsing behaviors in the social networking service of the at least one member and the first member meet a threshold of similarity.

5. The computer-implemented of claim 4, further comprising:
receiving an indication of a new browsing behavior during the first member's attempt to make the product purchase decision; and
dynamically updating the browsing behaviors of the first member based on the new behavior; and
re-determining whether the respective browsing behaviors in the social networking service of the at least one member and the first member meet the threshold of similarity.

6. The computer-implemented of claim 3, wherein determining whether at least one member in the social networking service similar to the first member comprises:
determining whether respective social network profiles of the at least one member and the first member meet a threshold of similarity.

7. The computer-implemented of claim 6, wherein determining whether respective social network profiles of the at least one member and the first member meet a second threshold of similarity comprises:
determining whether the threshold of similarity is met based on the respective social network profiles having in common at least one of: an education attribute; an employer attribute, a previous employer attribute, a skills attribute, a geographic attribute, and an attribute provided by other members in the social networking service.

8. The computer-implemented of claim 3, wherein determining whether at least one member in the social networking service similar to the first member comprises:
determining whether a social network distance between the at least one member and the first member falls within a threshold social network distance.

9. The computer-implemented of claim 3, wherein identifying a product browsing pattern associated with the at least one member comprises:
identifying at least one product browsing pattern associated with the at least one member that meets a threshold of similarity with the first member's current browsing pattern as the first member attempts to make the product purchase decision.

10. A non-transitory computer-readable medium storing executable instructions thereon, which, when executed by a processor, cause the processor to perform operations including:
determining a first member from a plurality of members in a social networking service is currently attempting to make a product purchase decision;
determining a product recommendation for the first member based at least in part on respective browsing behaviors in the social networking service of a subset of the plurality of members; and
providing the product recommendation to the first member.

11. The non-transitory computer-readable medium of claim 10, wherein determining a first member from a plurality of members is making a product purchase decision comprises one of:
determining the first member is browsing products available for purchase in the social networking service; and
determining the first member has requested a particular page of a product purchase portion of the social networking service.

12. The non-transitory computer-readable medium of claim 10, wherein determining a product recommendation for the first member based at least in part on respective browsing behaviors in the social networking service of a subset of the plurality of members comprises:
determining whether at least one member in the social networking service is similar to the first member;
upon determining a similarity between the at least one member and the first member, identifying a product browsing pattern associated with the at least one member;
identifying a product purchased upon completion of the product browsing pattern; and
creating the product recommendation based at least in part on the product purchased upon completion of the product browsing pattern.

13. The non-transitory computer-readable medium of claim 12, wherein determining whether at least one member in the social networking service similar to the first member comprises:
determining whether respective browsing behaviors in the social networking service of the at least one member and the first member meet a threshold of similarity.

14. The non-transitory computer-readable medium of claim 13, further comprising:
receiving an indication of a new browsing behavior during the first's member's attempt to make the product purchase decision; and
dynamically updating the browsing behaviors of the first member based on the new behavior; and
re-determining whether the respective browsing behaviors in the social networking service of the at least one member and the first member meet the threshold of similarity.

15. The non-transitory computer-readable medium of claim 12, wherein determining whether at least one member in the social networking service similar to the first member comprises:
determining whether respective social network profiles of the at least one member and the first member meet a threshold of similarity.

16. The non-transitory computer-readable medium of claim 15, wherein determining whether respective social network profiles of the at least one member and the first member meet a second threshold of similarity comprises:
determining whether the threshold of similarity is met based on the respective social network profiles having in common at least one of: an education attribute; an employer attribute, a previous employer attribute, a skills attribute, a geographic attribute, and an attribute provided by other members in the social networking service.

17. The non-transitory computer-readable medium of claim 12, wherein determining whether at least one member in the social networking service similar to the first member comprises:
determining whether a social network distance between the at least one member and the first member falls within a threshold social network distance.

18. The non-transitory computer-readable medium of claim 12, wherein identifying a product browsing pattern associated with the at least one member comprises:
identifying at least one product browsing pattern associated with the at least one member that meets a threshold of similarity with the first member's current browsing pattern as the first member attempts to make the product purchase decision.

19. A computer-implemented method comprising:
determining a first member from a plurality of members in a social networking service is currently attempting to make a product purchase decision;
while the first member attempts to make the product purchase decision:
(i) identifying at least one product browsing pattern that meets a threshold of similarity with the first member's current browsing pattern as the first member attempts to make the product purchase decision, the at least one product browsing pattern comprising a browsing pattern associated with at least one member similar to the first member which resulted in a purchase of at least one product from the social networking service;
(ii) determining a first product recommendation for the first member based at least in part on the at least one product; and
(iii) providing the first product recommendation to the first member.

20. The computer-implemented method of claim 19, comprising:
detecting a change in the first member's current browsing pattern; and
determining a second product recommendation for the first member based at least in part on at least one product purchased as a result of at least one product browsing pattern that meets the threshold of similarity with the first member's changed browsing pattern.
